(19) United States
(12) Patent Application Publication
(10) Pub. No.: US 2026/0009499 A1
(43) Pub. Date: Jan. 8, 2026

(54) DETACHABLE HANGING PLATE WITH LOCKING STRUCTURE

(71) Applicant: NINGBO ANLEI ELECTRONIC TECHNOLOGY CO., LTD, YUYAO (CN)

(72) Inventors: Lianyue HAN, Yuyao (CN); Ruojun FEI, Cixi (CN)

(73) Assignee: NINGBO ANLEI ELECTRONIC TECHNOLOGY CO., LTD, YUYAO (CN)

(21) Appl. No.: 19/260,428

(22) Filed: Jul. 4, 2025

(30) Foreign Application Priority Data
Jul. 4, 2024 (CN) 2024215709185

(51) Int. Cl. F16M 13/02

(52) U.S. Cl. CPC F16M 13/022

(57) ABSTRACT

The present utility model belongs to the technical field of production of hanging plates, and discloses a detachable hanging plate with a locking structure. The detachable hanging plate includes a hanging plate body hooked with a guide slot of a fixed plate, where a notch allowing the external fixed plate to be embedded is formed in a side surface of the hanging plate body, thereby hooking the hanging plate body with the fixed plate; a locking portion penetrating through front and back surfaces of the hanging plate body is further arranged on a surface of the hanging plate body, the locking portion has a handheld end and an abutting end opposite to the handheld end, and an end surface of the abutting end is clamped with the guide slot of the external fixed plate, thereby locking the abutting end with the guide slot.

### CROSS-REFERENCE TO RELATED APPLICATIONS

The application claims priority to Chinese patent application No. 2024215709185, filed on Jul. 4, 2024, the entire contents of which are incorporated herein by reference.

### TECHNICAL FIELD

The present utility model relates to the technical field of production of hanging plates, in particular to a detachable hanging plate with a locking structure.

### BACKGROUND

A hanging plate is a plate-type connecting member, is configured to be hooked with a fixed plate, and is configured to provide a supporting platform for objects. After the existing hanging plate is hooked with the fixed plate, the problem of back-and-forth swaying occurs, and if the supported object is too heavy, the hanging plate may be separated from the fixed plate, causing the object to fall, which causes damage to the object.

### SUMMARY

To solve the above technical problem, a detachable hanging plate with a locking structure is provided. After the detachable hanging plate is hooked with a fixed plate, the two plates are fixed through a locking structure, so that the supporting force of the hanging plate is increased, the hanging plate may not be separated from the fixed plate, and the hooking stability of the two plates is improved.

To achieve the above purpose, the technical solution adopted by the present utility model is as follows: a detachable hanging plate with a locking structure, including a hanging plate body hooked with a guide slot of a fixed plate, where a notch allowing the external fixed plate to be embedded is formed in a side surface of the hanging plate body, thereby hooking the hanging plate body with the fixed plate;
a locking portion penetrating through front and back surfaces of the hanging plate body is further arranged on a surface of the hanging plate body, the locking portion has a handheld end and an abutting end opposite to the handheld end, and an end surface of the abutting end is clamped with the guide slot of the external fixed plate, thereby locking the abutting end with the guide slot; and
a hanging portion is arranged on a front surface of the hanging plate body and is configured to hang an object.

According to the present utility model, furthermore, an overlap portion is formed at the top of the hanging plate body, a positioning portion is formed at the bottom of the hanging plate body, the overlap portion is provided with a connecting plate parallel with the positioning portion, and the connecting plate, the hanging plate body and the positioning portion jointly form the notch.

According to the present utility model, furthermore, an overlap plate extending obliquely upwards and forming an included angle with the connecting plate is connected at one end of the connecting plate.

According to the present utility model, furthermore, the locking portion is in threaded connection with the hanging plate body, and the abutting end is controlled by means of loosening or tightening to be embedded into or separated from the guide slot of the fixed plate.

According to the present utility model, furthermore, the end surface of the abutting end is provided with a long-stripe-shaped locking piece, and the locking piece is embedded into the guide slot of the fixed plate to achieve reinforced locking.

According to the present utility model, furthermore, the hanging portion is a separate first U-shaped hook, a vertical section on one side of the first U-shaped hook is fixedly connected to the front surface of the hanging plate body, an opening of the first U-shaped hook faces upwards, and a vertical section on the other side of the first U-shaped hook is a free end for hanging the object.

According to the present utility model, furthermore, the hanging portion includes two second U-shaped hooks arranged in parallel, a vertical section on one side of each of the second U-shaped hooks is fixedly connected to the front surface of the hanging plate body, an opening of each of the second U-shaped hooks faces upwards, a vertical section on the other side of each of the second U-shaped hooks is a free end for hanging the object, and a connecting rod is integrally formed on top surfaces of the vertical sections serving as the free ends and connects the vertical sections of the two second U-shaped hooks serving as the free ends into an integrated structure.

According to the present utility model, furthermore, the hanging portion includes a first connecting portion fixedly connected to the surface of the hanging plate body and extending distally, and a clamping jaw is connected to a distal end of the first connecting portion.

Compared with the prior art, the present utility model has the beneficial effects as follows: by additionally providing the locking portion, after the hanging plate body is hooked with the fixed plate, an additional locking force is provided for the fixed plate, thereby increasing the attaching tightness of the hanging plate body with the surface of the fixed plate, and reducing the probability of separation of the hanging plate body from the fixed plate.

The included angle formed by the connecting plate and the overlap plate is matched with the guide slot of the fixed plate, thereby improving the hooking firmness between the hanging plate body and the fixed plate.

### BRIEF DESCRIPTION OF DRAWINGS

FIG. 1 is a structural schematic diagram of embodiment 1 of a detachable hanging plate with a locking structure in the present utility model;

FIG. 2 is a structural schematic diagram of embodiment 2 of the detachable hanging plate with the locking structure in the present utility model;

FIG. 3 is a structural schematic diagram of embodiment 3 of the detachable hanging plate with the locking structure in the present utility model; and

FIG. 4 is a structural schematic diagram of embodiment 4 of the detachable hanging plate with the locking structure in the present utility model.

In the drawings: 100—hanging plate body, 110—overlap portion, 111—connecting plate, 112—overlap plate, 120—positioning portion, 200—locking portion, 210—handheld end, 220—abutting end, 221—locking piece, 300—hanging portion, 310—first U—shaped hook, 320—second U—shaped hook, 321—connecting rod, 330—first connecting portion, 340—clamping jaw, 350—second connecting portion, 360—clamping jaw, 361—first clamping jaw, 362—second clamping jaw.

### DETAILED DESCRIPTION OF THE EMBODIMENTS

The descriptions below are used for disclosing the present utility model, so that a person skilled in the art can implement the present utility model. The preferred embodiments in the descriptions below are only for the purpose of illustration, and a person skilled in the art would have been able to conceive of other obvious variations.

### Embodiment 1

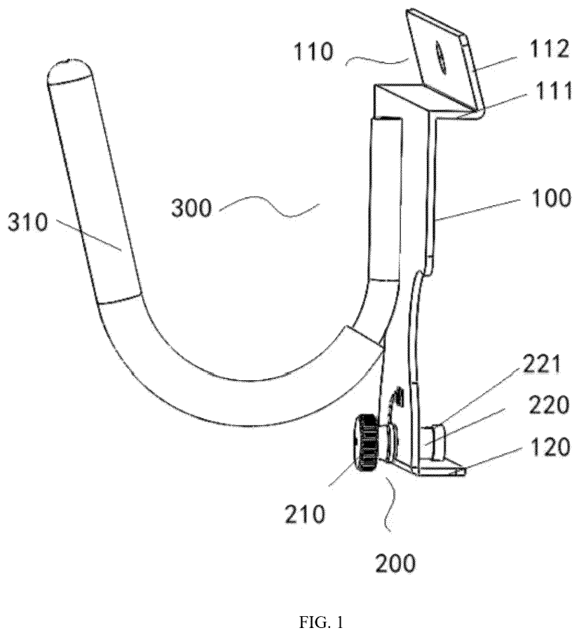

As shown in FIG. 1, a detachable hanging plate with a locking structure in the present utility model includes a hanging plate body 100, and the hanging plate body 100 and a fixed plate with guide slots are hooked into an integrated structure for supporting an object. A plurality of parallel guide slots are provided on a surface of the fixed plate. In this embodiment, the two adjacent guide slots are respectively named the first guide slot and the second guide slot, an overlap portion 110 matched with the first guide slot is formed at one end of the hanging plate body 100, a positioning portion 120 is formed at the other end of the hanging plate body 100, and the positioning portion 120 is embedded into the second guide slot, thereby hooking the hanging plate body 100 with the fixed plate. Preferably, the hanging plate body 100 is a thin plate with parallel top and bottom surfaces, the positioning portion 120 is integrally formed with the bottom surface and extends towards one side away from the hanging plate body 100 by forming a right angle with the hanging plate body 100, the overlap portion 110 is provided with a connecting plate 111 parallel to the positioning portion 120, the connecting plate 111 is parallel with the positioning portion 120, and a distance between the two parts corresponds to a distance between the two adjacent guide slots of the fixed plate, so that the hanging plate body 100 may be accurately attached to a plane of the fixed plate between the two guide slots; to reduce the probability of falling of the hanging plate body, an overlap plate 112 extending obliquely upwards and forming an included angle with the connecting plate 111 is connected at one end of the connecting plate 111, and the overlap plate 112 is matched with the guide slot to play a role in clamping, thereby improving the connection stability of the two parts. Preferably, the overlap plate 112 is integrally formed with the connecting plate 111, thereby avoiding separation of the overlap plate 112 from the connecting plate 111 due to supporting of the heavy object, and improving the overall strength.

Arc-shaped through slots may be formed in left and right edges of the hanging plate body 100, so that the appearance is attractive, materials may be saved during the machining process, and waste of production raw materials may be reduced.

To improve the hooking stability of the hanging plate body 100 with the fixed plate, a locking portion 200 is arranged on the surface of the hanging plate body 100, the locking portion 200 penetrates through front and rear surfaces of the hanging plate body 100, one end is a handheld end 210 rotated by a user, the other end opposite to the handheld end 210 is an abutting end 220, the abutting end 220 is embedded into the second guide slot, and the abutting end 220 is tightened to lock the abutting end 220 with the second guide slot. Before the hanging plate body 100 is hooked with the fixed plate, the end surface of the abutting end 220 is close to the rear surface of the hanging plate body 100, and after the positioning portion 120 and the overlap portion 110 are clamped with the corresponding guide slots, the handheld end 210 applies a force to embed the end surface of the abutting end 220 into the second guide slot of the fixed plate, thereby adding a locking extruding force perpendicular to the surface of the fixed plate, and improving the hooking firmness between the hanging plate body 100 and the fixed plate. Preferably, a threaded hole allowing the locking portion 200 to pass through is formed in the surface of the hanging plate body 100, an external thread matched with the threaded hole is arranged on an outer circumferential surface of the locking portion 200, and through loosening or tightening of the thread, the end surface of the abutting end 220 is controlled to be embedded into or separated from the second guide slot of the fixed plate, that is, the locking portion 200 is controlled to be locked or separated.

To improve the locking performance of the abutting end 220, the end surface of the abutting end 220 is provided with a long-stripe-shaped locking piece 221, the width of which is less than the width of the corresponding guide slot, and the length of which corresponds to the internal longitudinal width of the corresponding guide slot. The longitudinal direction here is a direction relative to the horizontal extension direction of the guide slot. The locking piece 221 is horizontal relative to the guide slot and is embedded into the guide slot, the handheld end 210 is rotated to enable the locking piece 221 to be in an inclined or vertical state to be clamped into the corresponding guide slot, thereby achieving further locking, and then the positioning portion 120 may not be easily separated from the corresponding guide slot.

A hanging portion 300 for supporting the object is connected to a front surface of the hanging plate body 100. Preferably, the hanging portion 300 is a separate first U-shaped hook 310, a vertical section on one side of the first U-shaped hook is fixedly connected to the front surface of the hanging plate body 100, an opening of the first U-shaped hook 310 faces upwards, a vertical section on the other side of the first U-shaped hook is a free end for hanging the object, and the object is provided with a hanging strap or hanging hole hooked with the vertical section serving as the free end, thereby hanging the object.

### Embodiment 2

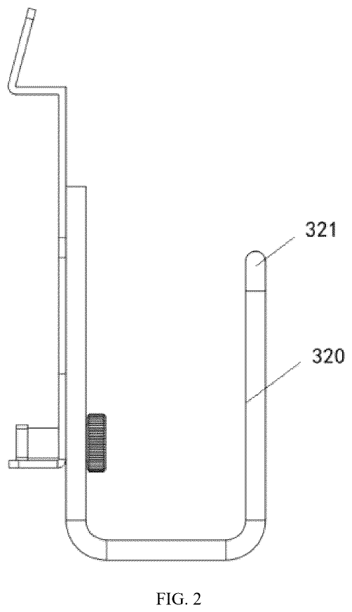

As shown in FIG. 2, in this embodiment, the structure of the hanging plate body 100 is as shown in embodiment 1, and is not repeated here. The hanging portion 300 includes two second U-shaped hooks 320 arranged in parallel, a vertical section on one side of each of the second U-shaped hooks 320 is fixedly connected to the front surface of the hanging plate body 100, an opening of each of the second U-shaped hooks 320 faces upwards, a vertical section on the other side of each of the second U-shaped hooks is a free end for hanging the object, and a connecting rod 321 is integrally formed on top surfaces of the vertical sections serving as the free ends and connects the vertical sections of the two second U-shaped hooks 320 serving as the free ends into an integrated structure. The supporting area of the hanging portion 300 is enlarged, and said portion may not only hang the object provided with the hanging strap, but also support the object having the slightly larger area by crossing the openings of the two second U-shaped hooks 320.

### Embodiment 3

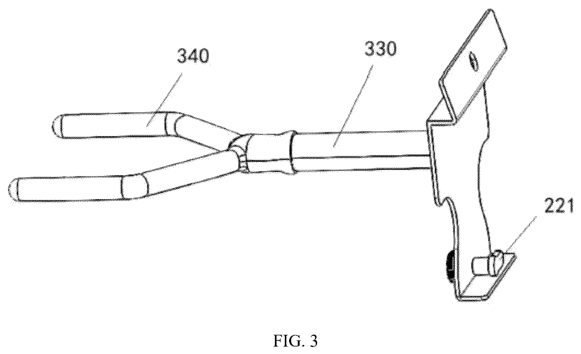

As shown in FIG. 3, in this embodiment, the structure of the hanging plate body 100 is as shown in embodiment 1, and is not repeated here. The hanging portion 300 includes a first connecting portion 330 fixedly connected to the surface of the hanging plate body 100 and extending distally, a clamping jaw 340 is connected to a distal end of the first connecting portion 330 and configured to clamp the object having the relatively large diameter and having no hanging strap or hanging hole, the clamping jaw 340 is provided with an opening, the object is placed into the clamping jaw 340 through the opening, and the object is positioned through the clamping jaw 340, thereby achieving the supporting function. The supported object may be an object having micro-elasticity and having the diameter greater than that of the opening of the clamping jaw 340, and is attached and fixed to the clamping jaw 340 by means of its own elasticity to avoid falling;

and the object may also be an object provided with a boss and having the diameter greater than that of the opening of the clamping jaw 340, the boss is arranged above the clamping jaw 340, and the positions of the two parts are fixed, thereby achieving the supporting function of the hanging portion 300.

### Embodiment 4

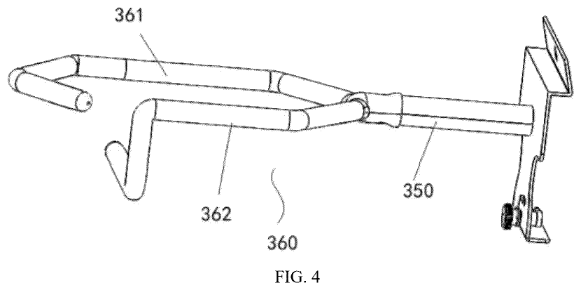

As shown in FIG. 4, in this embodiment, the structure of the hanging plate body 100 is as shown in embodiment 1, and is not repeated here. The hanging portion 300 includes a second connecting portion 350 fixedly connected to the surface of the hanging plate body 100 and extending distally, a clamping jaw 360 is connected to a distal end of the second connecting portion 350, the clamping jaw 360 includes a first clamping jaw 361 and a second clamping jaw 362 which are not located on the same plane, a distal end of the first clamping jaw 361 is of a half-enclosed structure and is located above the second clamping jaw 362, a distal end of the second clamping jaw 362 is an L-shaped supporting end, a right angle thereof faces the first clamping jaw 361, is located between the distal end of the first clamping jaw 361 and the second connecting portion 350, and is used for placing the relatively large object, a bottom end of the object is supported by the L-shaped supporting end of the second clamping jaw 362, the periphery is located inside a circle of the half-enclosed structure of the distal end of the first clamping jaw 361, and two points determine a straight line to place the object.

The basic principles, main features and advantages of the present utility model are shown and described above. A person skilled in the art should understand that the present utility model is not limited by the above embodiments, the descriptions in the above embodiments and specification are only principles of the present utility model, the present utility model may be subjected to various changes and improvements without departing from the spirit and scope of the present utility model, and these changes and improvements should fall within the scope of protection of the present utility model. The scope of protection of the present utility model should be subject to the appended claims and equivalents thereof.

1. A detachable hanging plate with a locking structure, comprising a hanging plate body hooked with a guide slot of a fixed plate, wherein a notch allowing the external fixed plate to be embedded is formed in a side surface of the hanging plate body, thereby hooking the hanging plate body with the fixed plate;
a locking portion penetrating through front and back surfaces of the hanging plate body is further arranged on a surface of the hanging plate body, the locking portion has a handheld end and an abutting end opposite to the handheld end, and an end surface of the abutting end is clamped with the guide slot of the external fixed plate, thereby locking the abutting end with the guide slot; and
a hanging portion is arranged on a front surface of the hanging plate body and is configured to hang an object.

2. The detachable hanging plate with a locking structure according to claim 1, wherein an overlap portion is formed at the top of the hanging plate body, a positioning portion is formed at the bottom of the hanging plate body, the overlap portion is provided with a connecting plate parallel with the positioning portion, and the connecting plate, the hanging plate body and the positioning portion jointly form the notch.

3. The detachable hanging plate with a locking structure according to claim 2, wherein an overlap plate extending obliquely upwards and forming an included angle with the connecting plate is connected at one end of the connecting plate.

4. The detachable hanging plate with a locking structure according to claim 1, wherein the locking portion is in threaded connection with the hanging plate body, and the abutting end is controlled by means of loosening or tightening to be embedded into or separated from the guide slot of the fixed plate.

5. The detachable hanging plate with a locking structure according to claim 1, wherein the end surface of the abutting end is provided with a long-stripe-shaped locking piece, and the locking piece is embedded into the guide slot of the fixed plate to achieve reinforced locking.

6. The detachable hanging plate with a locking structure according to claim 1, wherein the hanging portion is a separate first U-shaped hook, a vertical section on one side of the first U-shaped hook is fixedly connected to the front surface of the hanging plate body, an opening of the first U-shaped hook faces upwards, and a vertical section on the other side of the first U-shaped hook is a free end for hanging the object.

7. (canceled)

8. (canceled)
